(19) United States
(12) Patent Application Publication
(10) Pub. No.: US 2026/0184608 A1
(43) Pub. Date: Jul. 2, 2026

(54) TUNNEL-STRUCTURED ZETA-V2O5 AS A REDOX-ACTIVE INSERTION HOST FOR HYBRID CAPACITIVE DEIONIZATION

(71) Applicant: The Texas A&M University System, College Station, TX (US)

(72) Inventors: Sarbajit Banerjee, College Station, TX (US); Nicholas Isaac Cool, Phoenix, AZ (US)

(73) Assignee: The Texas A&M University System, College Station, TX (US)

(21) Appl. No.: 19/131,088

(22) PCT Filed: Nov. 22, 2023
(86) PCT No.: PCT/US23/80848

§ 371 Date: May 19, 2025

Related U.S. Application Data
(60) Provisional application No. 63/384,632, filed on Nov. 22, 2022.

(51) Int. Cl. C02F 1/461; C02F 1/28; C02F 1/44; C02F 1/469; C02F 103/08

(52) U.S. Cl. CPC C02F 1/46109; C02F 1/28; C02F 1/442; C02F 1/4691; C02F 2001/46133; C02F 2103/08; C02F 2201/008; C02F 2201/46115; C02F 2201/46165; C02F 2303/22

(57) ABSTRACT

Disclosed is a hybrid capacitive deionization cell (HCDI) that uses ζ-V₂O₅ as the positive electrode. Also disclosed are systems and methods for using an HCDI cell that uses ζ-V₂O₅ as the positive electrode for desalination of aqueous solutions and/or the recovery' of ions such as lithium, potassium, and sodium.

### RELATED APPLICATION

The present application claims the benefit of U.S. Provisional Application No. 63/384,632, filed Nov. 22, 2022, which is incorporated herein by reference in its entirety.

### TECHNICAL FIELD

This disclosure relates to desalination systems and methods, including specifically a system using a hybrid capacitive deionization cell (HCDI) with ζ-V₂O₅ nanowires as the positive electrode.

### BACKGROUND OF THE INVENTION

Much of the earth's water has salt content that is too high for human consumption or agricultural use. Enhanced oil recovery operations generate massive volumes of produced water waste with high mineral content that can substantially exacerbate water distress. Current deionization techniques such as reverse osmosis function by removing the water (majority phase) from the salt (minority phase), and are thus exceedingly energy intensive. Furthermore, these methods are limited in their ability to selectively extract high-value ions from of produced water waste and brine streams.

Fresh water is an increasingly valuable and scarce commodity across the world; substantial recent efforts have focused on desalination of sea water, brackish water, and flowback and produced water (FPW) brought to the surface using hydraulic fracturing. Despite notable advances in membrane design and process intensification, the majority of current desalination techniques such as reverse osmosis, multi-stage-flash distillation, and direct solvent extraction require exceedingly high energy budgets. In each of these techniques, the majority phase (water) is removed from the minority phase (dissolved salt ions), thereby requiring significant energy input to drive selective transport processes.

Furthermore, these techniques are limited in their selectivity towards specific ions, including such high-value ions such as lithium, transition metals, rare-earth elements, and uranium, which are present in FPW in substantial quantities, and are key to a new paradigm of resource recovery required for the energy transition.

FPW is also currently viewed as a considerable environmental liability. Scanlon and co-workers estimate that in the Permian Basin spanning across Texas and New Mexico. FPW generated from conventional and unconventional reservoirs was as much as ca. 40×10⁹ bbl and 4×10⁹ bbl, respectively, between the years 2005-2015. Owing to the high salinity of FPW and the complexity imbued by the presence of enhanced oil recovery additives, recovery and reuse of FPW is challenging, whereas reinjection in aquifers is subject to increasingly stringent regulations.

In conventional capacitive deionization (CDI) techniques, dissolved ions are removed from saline water by the application of a potential across a deionization cell comprising two high-surface-area carbon electrodes. In this process, the dissolved ions migrate to electrified interfaces and constitute an electric double layer of solvated ions; the concentration of stored ions is directly proportional to the accessible surface area of the electrodes. Several modifications have been implemented to increase the efficacy of CDI cells such as the implementation of electrodes with hierarchical porosity in order to increase the available surface area for ion adsorption, as well as the addition of ion-exchange membranes that impede the diffusion of counter-ions. While recent innovations have improved the capacity and efficiency of CDI cells, the fundamental drawback of this approach is that ion storage is limited to the electrical double layer formed on the wetted surfaces of the electrode material, which remains a substantial constraint.

Hybrid capacitive desalination (HDCI) stores ions within the interior volumes of materials through redox reactions akin to that of positive electrode materials of Li-ion batteries. Selectivity in ion extraction is engendered based on differences in insertion potentials, bulk diffusion coefficients, and interstitial site preferences of different ions. As such, hybrid capacitive deionization methods hold promise not just for enabling reuse of FPW in hydraulic fracturing operations, but also for enabling the extraction of high-value ions with high selectivity.

Similar considerations related to surface versus bulk storage of ions represent a key difference in the operational mechanisms of supercapacitors and intercalation batteries. In positive electrodes of Li-ion or other intercalation batteries, ions are stored in interstitial sites within the bulk of the electrode materials based on concomitant redox reactions. A key difference between HCDI and CDI is the operation of Faradic reactions in the former, which, in addition to electric double layer formation, results in interfacial desolvation and bulk diffusion of ions. Storing ions in interstitial sites, and not just within surface double layers, engenders a considerable increase in charge storage capacity. A notable trade-off is that insertion electrodes have a more sluggish rate of removal as a result of diffusion limitations and the operation of Faradaic processes at interfaces.

This disclosure demonstrates these limitations can be substantially alleviated through appropriate structuring of electrode tortuosity, control over crystallite dimensions, and modification of the structure and composition of the intercalation host. Insertion chemistry further provides a sensitive means of differentiating between uptake of different ions from aqueous media based on differentials in bulk diffusion coefficients and intercalation potentials, which in turn are governed by the crystal-lattice-dependent dimensions of interstitial sites, site-to-site migration barriers, and the thermodynamics of insertion reactions. Specifically, to overcome the challenges in recovery and reuse of FPW (or other salinated water) and the drawbacks with prior art methods, this disclosure describes an electrochemical approach for desalination and selective ion capture based on sequestration of ions within the 1D tunnels of ζ-V₂O₅, a versatile intercalation host for monovalent and multivalent ions.

All of the subject matter discussed in the Background is not necessarily prior art and should not be assumed to be prior art merely as a result of its discussion in the Background section. Along these lines, any recognition of problems in the prior art discussed in the Background or associated with such subject matter should not be treated as prior art unless expressly stated to be prior art. Instead, the discussion of any subject matter in the Background should be treated as part of the inventor's approach to the particular problem, which in and of itself, may also be inventive.

### SUMMARY OF THE INVENTION

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

The following describes tunnel-structured ζ-V₂O₅ (zeta-vanadium (V) oxide) as a redox-active insertion host for hybrid capacitive deionization useful in desalination devices, systems, and methods.

Specifically, a hybrid capacitive deionization (HDCI) cell that makes use of tunnel-structured ζ-V₂O₅ as a redox-active positive electrode material is shown to overcome many of the issues with prior technology. By augmenting surface adsorption with Faradaic insertion processes, a 50% improvement in the ion removal capacity for K- and Li-ions is obtained as compared to a capacitive high-surface-area carbon electrode. The extracted ions are accommodated in interstitial sites within the 1D tunnel framework of ζ-V₂O₅. The kinetics of ion removal depend on the free energy of hydration, which governs the ease of desolvation at the electrode/electrolyte interface. The overall ion removal capacity is a function primarily of the solid-state diffusion coefficient of the ion. ζ-V₂O₅ positive electrodes show substantial selectivity for Li⁺ removal from mixed flow streams and enrichment of Li-ion concentration from produced water waste derived from the Permian Basin.

ζ-V₂O₅ is a 1D tunnel-structured polymorph of V₂O₅, and used in this disclosure as a positive electrode material for a HCDI. Due to its high abundance of interstitial sites, accessibility of multi-electron redox on vanadium centers, low diffusion barriers for site-to-site ion migration, ability to insert a variety of cations, and excellent stability in aqueous media, it is highly effective in desalination methods. This disclosure describes the construction and implementation of HCDI cells based on ζ-V₂O₅ active electrodes for sequestration of Li⁺, Na⁺, and K⁺ ions from aqueous media, including specifically any aqueous media with a salinity above 1000 ppm. That sequestration includes the intercalative, and not just adsorptive, positioning of cations within the 1D tunnels of ζ-V₂O₅. Further, differences in site preferences, hydration radius, and hydration free energy allow for ion selectivity from mixed ion streams.

An embodiment of this disclosure is an HDCI cell comprising: a positive electrode material comprised of ζ-V₂O₅, a current collector, a cation exchange membrane, a separator layer, an anion exchange membrane, and a negative electrode material. The HDCI cell may also be comprised of a Delrin exterior. In addition, the ζ-V₂O₅ of the positive electrode may be modified, such as by substituting one or more of the vanadium sites with molybdenum, tungsten, or niobium, to alter the ion selectivity of the electrode material.

An embodiment of this disclosure includes a method comprising: electrochemically cycling an HDCI cell comprising a ζ-V₂O₅ positive electrode with an aqueous solution having a salinity above 1000 ppm; and removing at least one of lithium, potassium, or sodium ions from the aqueous solution. Preferably, lithium ions are removed from the aqueous solution in the method with a selectivity of lithium ion removal in a range from 10 to 10⁶ higher than for other ions.

An embodiment of this disclosure includes a method comprising: electrochemically cycling an HDCI cell comprising a ζ-V₂O₅ positive electrode with an aqueous solution having a salinity above 1000 ppm; removing lithium ions from the aqueous solution; electrochemically cycling the HDCI cell for selective removal of one or more other ions; and removing those other ions.

An embodiment of this disclosure includes a method comprising: electrochemically cycling an HDCI cell comprising a ζ-V₂O₅ positive electrode with an aqueous solution having a salinity above 1000 ppm; and removing at least one of lithium, potassium, or sodium ions from the aqueous solution, wherein each electrochemical cycle lasts for a duration of between 10 seconds and ninety minutes.

An embodiment of this disclosure includes a method comprising: electrochemically cycling an HDCI cell comprising a ζ-V₂O₅ positive electrode with an aqueous solution having a salinity above 1000 ppm; and removing at least one of lithium, potassium, or sodium ions from the aqueous solution, wherein the thickness of the ζ-V₂O₅ positive electrode is between 2 nm to 1000 μm.

An embodiment of this disclosure includes a method comprising: electrochemically cycling an HDCI cell comprising a ζ-V₂O₅ positive electrode with an aqueous solution having a salinity above 1000 ppm; and removing at least one of lithium, potassium, or sodium ions from the aqueous solution, wherein the temperature at which each step occurs is between 0° C. and 95° C.

An embodiment of this disclosure includes a method comprising: electrochemically cycling an HDCI cell comprising a ζ-V₂O₅ positive electrode with an aqueous solution having a salinity above 1000 ppm; and removing at least one of lithium, potassium, or sodium ions from the aqueous solution, wherein the aqueous solution is comprised of flowback, produced water, sea water, brackish water, geothermal brines, or synthetic brines. Preferably, the aqueous solution is one or more of flowback or produced water and the method further comprises filtering the aqueous solution to remove residual oil and dissolved solids before electrochemically cycling.

An embodiment of this disclosure includes an HDCI system for desalination at remote sites comprising: a conduit that may be attached to an aqueous solution storage tank, one or more additional conduits through which an aqueous solution may flow, a deoiling or desilting membrane connected to at least one of the conduits, a nanofiltration unit connected to at least one of the conduits and connected to an HDCI cell, and a vehicle or trailer, wherein the HDCI cell comprises: (i) a positive electrode material comprising ζ-V₂O₅, (ii) a current collector; (iii) a cation exchange membrane; (iv) a separator layer; (v) an anion exchange membrane; and (vi) a negative electrode material. This embodiment may further comprise: a unit for precipitation of solid material in the form of insoluble carbonates, hydroxides, or other salts, a water softening unit, an absorption column, a control system, a pump, a storage tank, or a power source, such as a generator, a battery, or a solar panel.

The details of one or more embodiments are set forth in the description below. The features illustrated or described in connection with one exemplary embodiment may be combined with the features of other embodiments. Thus, any of the various embodiments described herein can be combined to provide further embodiments. Aspects of the embodiments can be modified, if necessary, to employ concepts of the various patents, applications, and publications as identified herein to provide yet further embodiments. Other features, objects, and advantages will be apparent from the description, the drawings, and the claims.

### BRIEF DESCRIPTION OF THE DRAWINGS

The disclosure may be understood by reference to the following description taken in conjunction with the accompanying drawings, in which:

FIG. 1 shows a schematic illustration of the structure and components of a custom HDCI cell (101-108) connected to a peristaltic pump (109) and solution reservoir (110).

FIGS. 2A to 2C show a schematic illustration of stabilization of metastable ζ-V₂O₅ based on topochemical de-intercalation of Ag-ions from β-Ag_{0.33}V₂O₅. The crystal structures of the (A) α-V₂O₅, (B) β-Ag_{0.33}V₂O₅, and (C) ζ-V₂O₅ product are shown. FIGS. 2D to 2F show the β, β′, and C interstitial sites of ζ-V₂O₅ arrayed along a 1D tunnel.

FIG. 3 shows a refined x-ray diffraction (XRD) pattern of ζ-V₂O₅ nanowires, specifically, a Rietveld refinement of powder XRD pattern of ζ-V₂O₅ prepared from a β-Ag_{0.33}V₂O₅ precursor. The XRD data is plotted (33) on top of the plotted refined pattern (32). Residual values are shown as 30 and the background is plotted as 31. The refined crystal structure is shown with partial remnant Ag occupancy in β sites of the 1D tunnel.

FIG. 4 shows scanning electronic microscopy (SEM) (A), transmission electron microscopy (TEM) (B), and high-resolution, lattice-resolved TEM (C) images of the ζ-V₂O₅ nanowires.

FIG. 5 shows cycling data for potassium ion removal for CDI cells (A-D) and HDCI cells (E-H).

FIG. 6 Electrochemical cycling experiments contrasting CDI (A-D) and HCDI (E-H) cells with an aqueous solution of 15 mM NaCl flowed at 20 mL/min. The cells were cycled at 1.2 V for times varying from 15 minutes to 2 hours and then the potential was reversed to −1.2V. The cells were cycled a total of 40 times. Data was plotted as the conductivity of the aqueous solution versus time. The average IRC across the cycles is inset into each plot.

FIG. 7 shows electrochemical cycling results contrasting CDI (A-D) cells and HCDI (E-H) cells with aqueous solutions of 15 mM LiCl flowed at a constant flow rate of 20 mL/min. The cells were cycled at 1.2 V for times varying from 15 minutes to 2 hours and then the potential was reversed to −1.2V. The cells were cycled a total of 40 times. Data was plotted as the conductivity of the solution versus time. The average IRC across the cycles is inset into each plot.

FIG. 8 shows x-ray photospectrometry (XPS) characterization of ζ-V₂O₅ composite desalination electrodes, specifically high-resolution XPS data of (A) High-resolution O 1s and V 2p_{3/2} XPS data for an uncycled ζ-V₂O₅ positive electrode; (B) a representative Cl 2p scan for a recovered ζ-V₂O₅ electrode which was cycled at 1.2 V with a constant flow rate of 20 mL/min and then stopped on an ion uptake step, (C) a O 1s and a V 2p_{3/2} scan of a 15 mM aqueous solution of KCl cycled through the HCDI ζ-V₂O₅ positive electrode material at a constant flow rate of 20 mL/min and a potential of 1.2 V; (D) a K 2p scan of a 15 mM aqueous solution of KCl cycled through the HCDI ζ-V₂O₅ positive electrode material at a constant flow rate of 20 mL/min, a potential of 1.2 V, and then stopped on an ion uptake step. (E) a O 1s and a V 2p_{3/2} scan of a 15 mM aqueous solution of NaCl cycled through the HCDI ζ-V₂O₅ positive electrode material at a constant flow rate of 20 mL/min, a potential of 1.2 V, and then stopped on an ion uptake step; (F) a Na is scan of a 15 mM aqueous solution of NaCl cycled through the HCDI ζ-V₂O₅ positive electrode material at a constant flow rate of 20 mL/min, a potential of 1.2 V, and then stopped on an ion uptake step; (G) a O 1s and a V 2p_{3/2} scan of a 15 mM aqueous solution of LiCl cycled through the HCDI ζ-V₂O₅ positive electrode material at a constant flow rate of 20 mL/min, a potential of 1.2 V, and then stopped on an ion uptake step; and (H) a Li 1s scan of a 15 mM aqueous solution of LiCl cycled through the HCDI ζ-V₂O₅ positive electrode material at a constant flow rate of 20 mL/min, a potential of 1.2 V, and then stopped on an ion uptake step. Peak identification is inlayed into each panel with the oxidation states of V identified.

FIG. 9 shows shows x-ray photospectrometry (XPS) characterization of ζ-V₂O₅ composite desalination electrodes, specifically, high resolution XPS data of (A) a O 1s and V 2p_{3/2} scan of 5 mM KCl, 5 mM NaCl. and 5 mM LiCl cycled through the HCDI ζ-V₂O₅ positive electrode material at a constant flow rate of 20 mL/min, a potential of 1.2 V, and then stopped on an ion uptake step; (B) a Na is scan of 5 mM KCl, 5 mM NaCl. and 5 mM LiCl cycled through the HCDI ζ-V₂O₅ positive electrode material at a constant flow rate of 20 mL/min, a potential of 1.2 V. and then stopped on an ion uptake step; (C) and a Li Is scan of 5 mM KCl, 5 mM NaCl, and 5 mM LiCl cycled through the HCDI ζ-V₂O₅ positive electrode material at a constant flow rate of 20 mL/min, a potential of 1.2 V, and then stopped on an ion uptake step. Peak identification is inlayed into each panel with the oxidation states of V identified.

FIG. 10 shows evidence of interstitial site filling from powder XRD, specifically. X-ray diffraction data for an uncycled ζ-V₂O₅ electrode as well as electrodes cycled with 15 mM solutions of KCl (1003), NaCl (1002), and LiCl (1001) and a solution containing 5 mM KCl, 5 mM NaCl, and 5 mM LiCl in deionized water (1000). The labels to each XRD pattern denote stoichiometries measured by ICP-MS.

FIG. 11 shows (A) desalination of a mixed salt solution with electrochemical cycling results for an HCDI cell with an aqueous solution of 5 mM LiCl, 5 mM NaCl, and 5 mM KCl flowed at a constant flow rate of 20 mL/min. The cell was cycled at 1.2 V for 2 h and then the potential was reversed to −1.2V. The cell was cycled a total of 40 times. Data is plotted as the conductivity of the solution versus time. (B) Desalination of a produced water stream in a cycling experiment for an HCDI cell is also shown for a 10 vol. % solution of FPW from a hydraulic fracturing operation in West Texas. The water was first filtered to remove residual oil and dissolved solids using a cement-based membrane and then flowed at a constant flow rate of 20 mL/min. The cell was cycled at 1.2 V for 2 h and then the potential was reversed to −1.2V. The cell was cycled a total of 40 times. Data is plotted as the conductivity of the solution vs time.

### DETAILED DESCRIPTION

Practical electrochemical desalination of FPW and brackish water streams requires fulfillment of a number of key performance constraints. First, the process must provide a high ion removal capacity (IRC) and the active materials must remain insoluble even when subject to modest pH excursions. Next, the sequestration of ions from flow streams must be entirely reversible so that the ions can be released in the form of concentrated brine streams and the cell can be continuously cycled. Third, the feasibility of a CDI process would be greatly enhanced if ion sequestration can be accomplished with some degree of selectivity, such as to enable selective capture of high-value ions. As described herein, these constraints can be satisfied by the use of HCDI cell with ζ-V₂O₅ positive electrodes.

The disclosed HDCI cells using ζ-V₂O₅ as the positive electrode (and systems incorporating such cells) are useful for desalination of water with a salinity higher than 1000 ppm, including sea water, brackish water, geothermal brines, synthetic brines, and flowback and/or produced water.

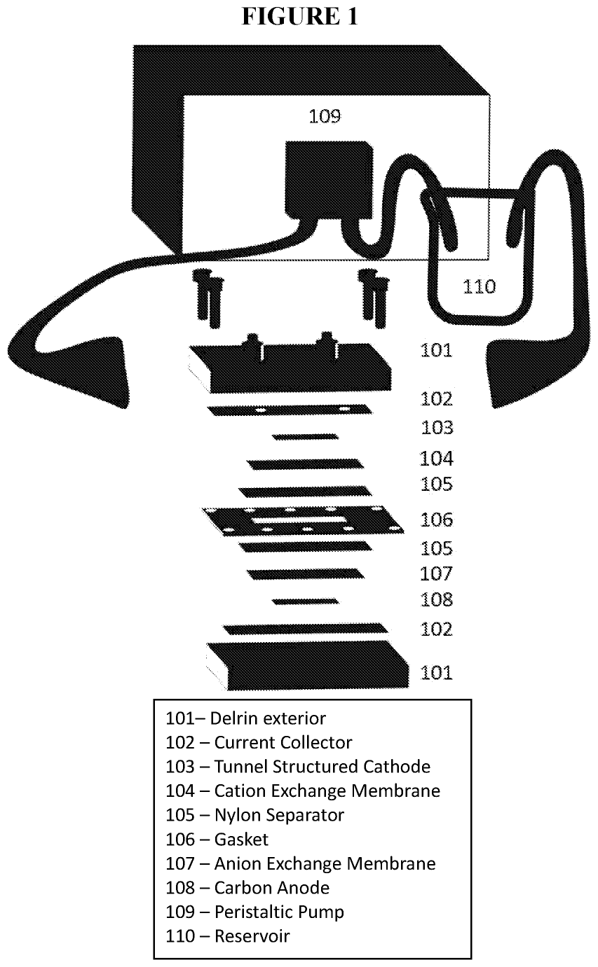

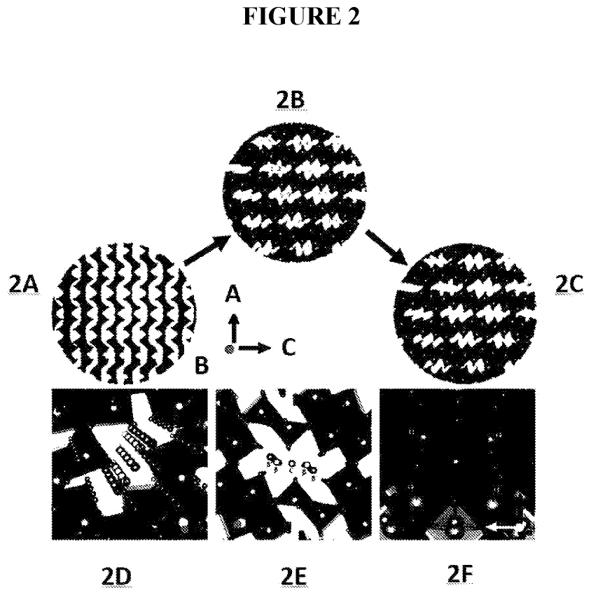

FIG. 1 illustrates the structure of an HDCI cell (with components 101-108) connected to a peristaltic pump (109) and a reservoir (110). Preferably, the exterior 101 is comprised of Delrin, which is polyoxymethylene, a high performance acetal resin. Building from the top down as depicted in FIG. 1, the next layer is a current collector (102), then a tunnel structured cathode (103) such as ζ-V₂O₅, then a cation exchange membrane (104), then a nylon separator (105), then a gasket (106), then an anion exchange membrane (107), then a carbon anode (108), then another current collector layer (102), then the exterior (101). Preferably, the ζ-V₂O₅ positive electrode has a thickness between 2 nm and 1000 sm. This system can be used in methods of desalination as further described herein.

ζ-V₂O₅ has attracted substantial recent interest as a battery positive electrode material owing to its high theoretical capacity (441 mAh/g), outstanding thermal and chemical stability, ability to accommodate Li- and Mg-ions through reordering of cation occupancies but without distortive phase transitions, low stress accumulation upon cation insertion, and excellent cyclability. Synthesis of a metastable vanadium pentoxide cathode material was previously described in U.S. Pub. No. 2020/0321614, which is herein incorporated by reference. The ζ-V₂O₅ polymorph comprises three crystallographically distinct vanadium centers, specifically, two distorted VO₆ octahedra interwoven by VOS square pyramids, which define a 1D tunnel oriented along the h-axis. In certain embodiments, one or more of these vanadium centers may be substituted with molybdenum, tungsten, or niobium to alter the ion selectivity of the electrode material. Standard solid-state chemistry methods can be used to perform such substitution where molybedenum, tungsten, or niobium are heated with vanadium precursors as a means of site-selective modification or doping.

FIG. 2A-2C shows the sequence of reactions used to stabilize ζ-V₂O₅. β-Ag_{0.33}V₂O₅ nanowires are prepared by the reaction of silver acetate with α-V₂O₅; topochemical deinsertion of Ag-ions by treatment with HCl, yields the ζ-V₂O₅ polymorph. ζ-V₂O₅ has multiple interstitial sites, β, β′, and C arrayed along the 1D tunnel, as shown in FIGS. 2D-2F.

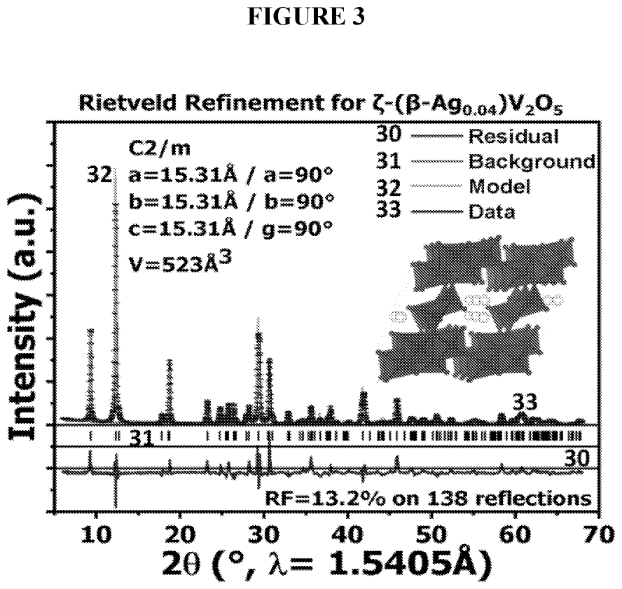

FIG. 3 shows a refined XRD pattern of ζ-V₂O₅ nanowires, specifically, a Rietveld refinement of powder XRD pattern of ζ-V₂O₅ prepared from a β-Ag_{0.33}V₂O₅ precursor. The XRD data is plotted (33) on top of the plotted refined pattern (32). Residual values are shown as 30 and the background is plotted as 31. The refined crystal structure is shown with partial remnant Ag occupancy in f sites of the 1D tunnel. The prepared nanowires are crystallized in a monoclinic C2/m space group with a β-angle of 110.0°.

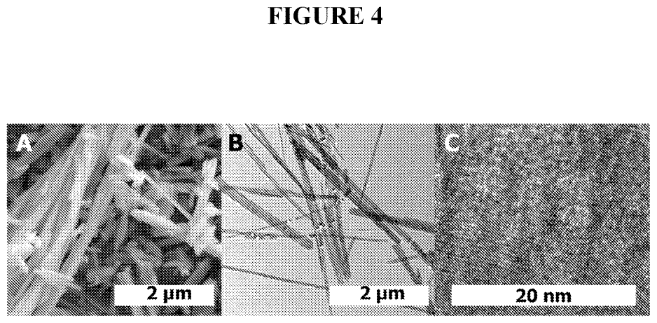

FIG. 4 shows SEM (A) and TEM (B) images of the ζ-V₂O₅ nanowires. The nanowires have approximately rectangular cross-sections with dimensions of 0.33 f 0.09 μm and range in length from 0.5-9 μm.

In order to demonstrate the viability of ζ-V₂O₅ as a positive electrode for HCDI, a flow cell with a ζ-V₂O₅ positive electrode and activated carbon negative electrode was compared with a conventional CDI cell with identical activated carbon negative electrode and positive electrode pair. The electrodes were prepared to the same specifications and used within the same exact flow cell varying just the active electrode material. Aqueous solutions of 15 mM NaCl, KCl, and LiCl have been used as the input flow streams. A constant potential was applied for varying time periods. In addition, to these test steams, additional tests were performed with (a) a mixed-salt aqueous solution with 5 mM each of NaCl, KCl, and LiCl and (b) a realistic FPW flowstream from the Permian Basin.

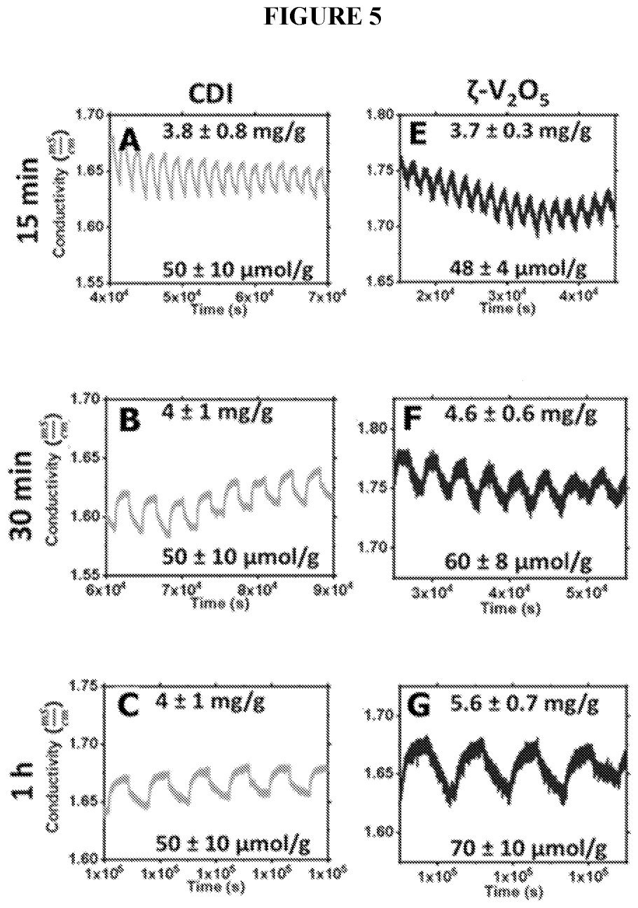

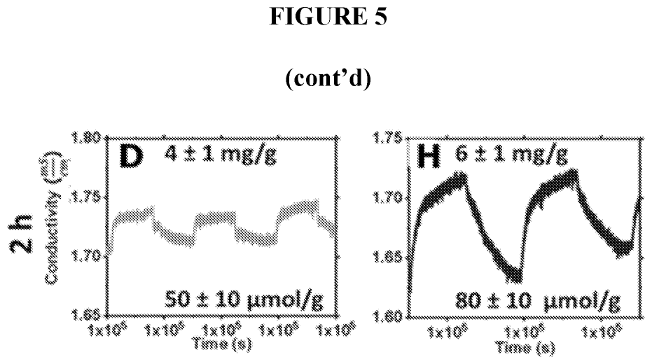

FIG. 5 contrasts cycling data for K-ion removal at a constant potential of 1.2 V for CDI and HCDI cells where the solution was flowed at a rate of 20 mL/min. The cells were cycled at 1.2V for times varying from 15 minutes to two hours and then the potential was reversed to −1.2V. The cells were cycled a total of 40 times. The CDI cells comprising activated carbon active electrodes rapidly reached their maximum ion removal capacity, peaking at a cycle time of 30 min, which reflected the limits of ions that could be sequestered at the surfaces of the electrodes. In contrast, HCDI cells showed characteristic signs of time-dependent ion removal (suggesting diffusion limitations from propagation of an intercalation wave), reaching an IRC of 6 mg/g, a 50% increase as compared to the CDI system after 2 hours. The duration of a cycle may be between 10 seconds and ninety minutes and preferably, the temperature at which such cycling occurs is between 0° C. and 95° C.

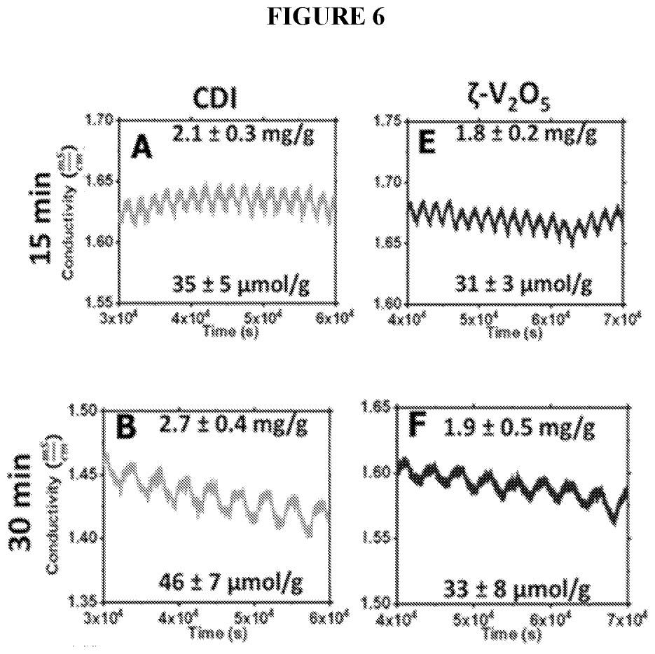

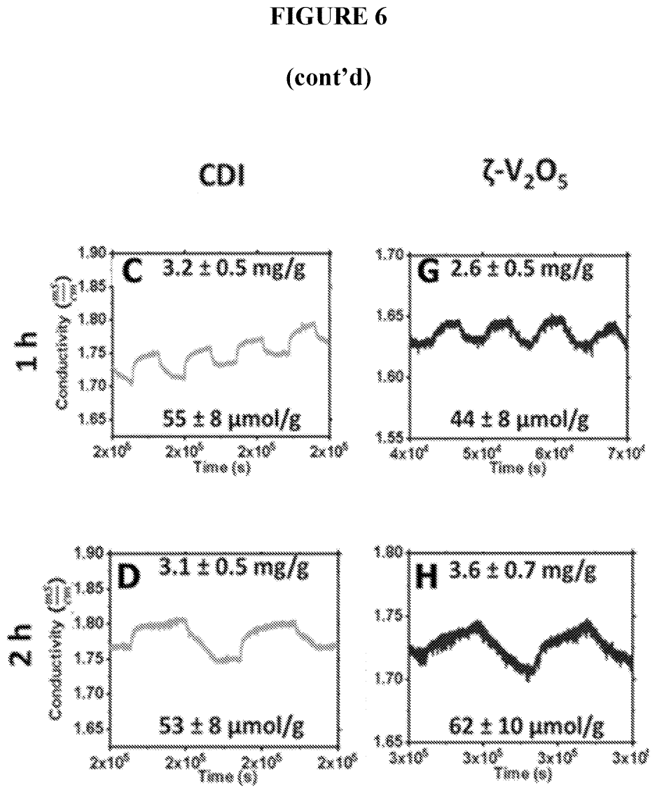

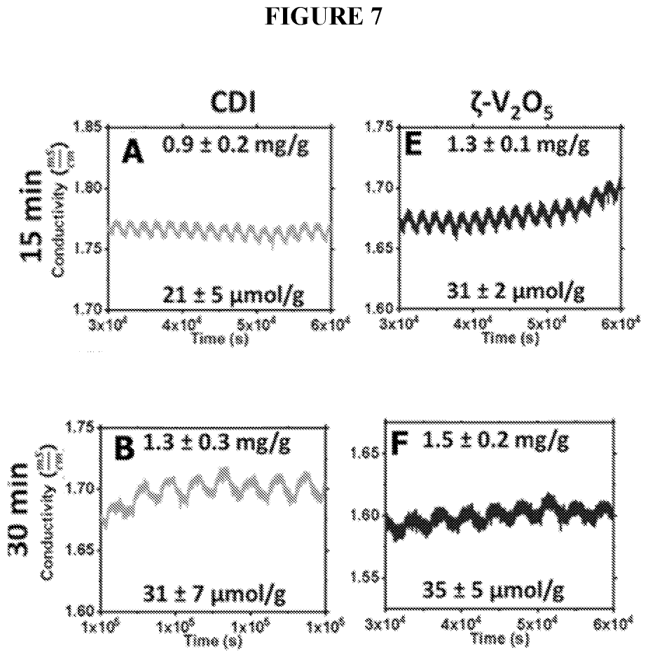

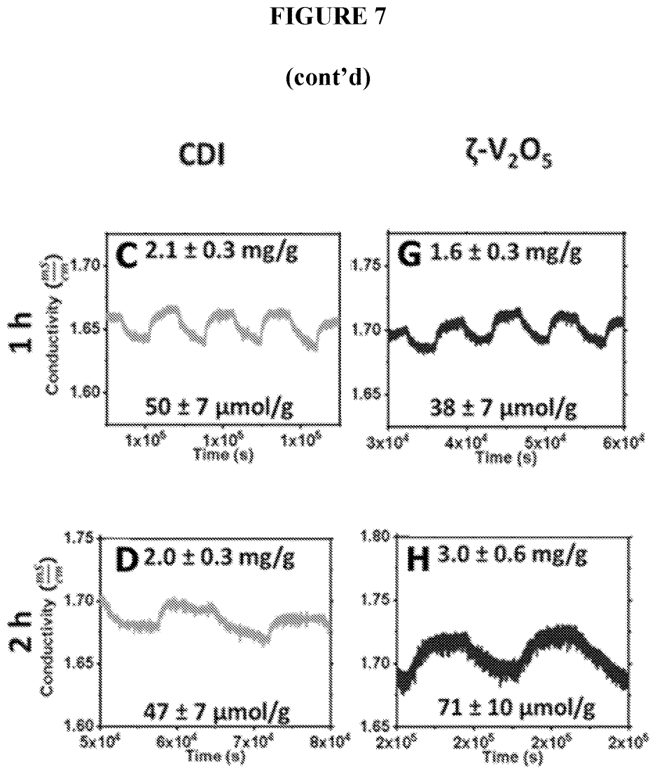

FIG. 6 and FIG. 7 contrast the IRC of CDI and HCDI configurations (the latter with ζ-V₂O₅ positive electrodes) towards aqueous solutions of Na⁺ and Li⁺ solutions; a 16% and 50% increase was observed in the IRC for ζ-V₂O₅ insertion as compared to non-specific capacitative removal, respectively. In FIG. 6, electrochemical cycling experiments compared CDI (A-D) and HCDI (E-H) cells with an aqueous solution of 15 mM NaCl (sodium chloride) flowed at 20 mL/min. The cells were cycled at 1.2 V for times varying from 15 minutes to 2 hours and then the potential was reversed to −1.2V. The cells were cycled a total of 40 times. Data was plotted as the conductivity of the aqueous solution versus time. The average IRC across the cycles is inset into each plot.

In FIG. 7, electrochemical cycling results compared CDI (A-D) cells and HCDI (E-H) cells with aqueous solutions of 15 mM LiCl (lithium chloride) flowed at a constant flow rate of 20 mL/min. The cells were cycled at 1.2 V for times varying from 15 minutes to 2 hours and then the potential was reversed to −1.2V. The cells were cycled a total of 40 times. Data was plotted as the conductivity of the solution versus time. The average IRC across the cycles is inset into each plot.

Table 1 summarizes the results for the three test aqueous solutions. Specifically, in Table 1 tabulated values of IRC contrast the performance of CDI and HCDI systems for input flowstreams of 15 mM aqueous solutions of KCl, NaCl, and LiCl flowed at a rate of 20 mL/min. The half-cycle times are denoted in the left-most column for each sample. Each value for IRC is represented in mg of salt removed per g of electrode (left) and μmol of salt removed per g of electrode (right). Values are shown as an average of the cycles demonstrated in FIG. 5 with the error demonstrating variation between cycles.

TABLE 1

| | | Ion Removal Capacity (mg/g) | | | | | | Ion Removal Capacity (μmol/g) | | | | | |
|---|---|---|---|---|---|---|---|---|---|---|---|---|---|
| | | Salt Solution | | | | | | | | | | | |
| | | KCl | | NaCl | | LiCl | | KCl | | NaCl | | LiCl | |
| Cell Type | | CDI | HCDI | CDI | HCDI | CDI | HCDI | CDI | HCDI | CDI | HCDI | CDI | HCDI |
| 15 | min | 3.8 ± 0.8 | 3.6 ± 0.3 | 2.1 ± 0.3 | 1.8 ± 0.2 | 0.9 ± 0.2 | 1.3 ± 0.1 | 50 ± 10 | 48 ± 4 | 35 ± 5 | 31 ± 3 | 21 ± 5 | 31 ± 2 |
| 30 | min | 4 ± 1 | 4.5 ± 0.6 | 2.7 ± 0.4 | 1.9 ± 0.5 | 1.3 ± 0.3 | 1.5 ± 0.2 | 50 ± 10 | 60 ± 8 | 46 ± 7 | 33 ± 8 | 31 ± 7 | 35 ± 5 |
| 1 | h | 4 ± 1 | 5.3 ± 0.8 | 3.2 ± 0.5 | 2.6 ± 0.5 | 2.1 ± 0.3 | 1.6 ± 0.3 | 50 ± 10 | 70 ± 10 | 55 ± 8 | 44 ± 8 | 50 ± 7 | 38 ± 7 |
| 2 | h | 4 ± 1 | 6 ± 1 | 3.1 ± 0.5 | 3.6 ± 0.7 | 2.0 ± 0.3 | 3.0 ± 0.6 | 50 ± 10 | 80 ± 10 | 53 ± 8 | 62 ± 10 | 47 ± 7 | 71 ± 10 |

Several trends are immediately discernible from Table 1. The kinetics of ion sequestration in CDI using activated carbon electrodes was relatively faster for K-ions; saturation was reached in 30 minutes, but about 1 hour was required for saturation of the activated carbon surfaces with Na and Li ions. This is consistent with the higher ionic conductivity of KCl aqueous solutions, concordant with the relatively smaller size of hydrated K-ions. In contrast, for HCDI with ζ-V₂O₅ active electrodes, relatively slower uptake is observed, which is attributable to the need for solid-state diffusion through the 1D tunnels after desolvation at the charged interface.

Potassium uptake in ζ-V₂O₅ surpasses the CDI system at a 30 min half-cycle time, whereas a 2 hour half-cycle time is needed for Li-ion insertion in ζ-V₂O₅ to surpass capacitive adsorption on activated carbon. This can be rationalized based on the hydration free energy differences between K⁺ and Li⁺ in aqueous media (271-343 kJ/mol and 515-544 kJ/mol, respectively). The higher hydrated ionic radius and greater hydration free energy poses a greater barrier to interfacial desolvation, suggesting a higher selectivity for K⁺ at shorter cycle times. However, the maximum IRC in moles after 2 h for HCDI is K (80 μmol/g), Na (62 μmol/g), Li (71 μmol/g) (Table 1), which indicates a balance between ionic and solvated radii of the ions and furthermore parallels the ordering of site-to-site migration barriers and solid-state diffusion coefficients for the three ions. While K has a smaller dehydration barrier and is much more rapidly able to desolvate and diffuse into the tunnels of ζ-V₂O₅ upon intercalation, fewer sites are available for potassium and sodium leaving the potential for greater lithium intercalation in a mixed stream or upon extended lithiations.

Preferably, in a method employing an HDCI cell according to this disclosure, the selective removal of lithium ions is in a range from 10 to 106 higher than for other ions present in the aqueous solution. In addition, the method could involve first selectively remove lithium ions through electrochemically cycling the HDCI cell under a first set of conditions, and electrochemically cycling the HDCI cell under a second set of conditions such that selectivity for another ion, for example, potassium or sodium, is increased resulting in removal of that ion.

ICP-MS (inductively coupled mass spectrometry) was performed on ζ-V₂O₅ electrodes recovered after discharge; the recovered material was washed three times with deionized water to remove surface-bound ions. Based on the ICP-MS measurements, stoichiometries of 0.66 Li, 0.18 Na, and 0.07 K per V₂O₅ formula unit were inferred, which suggests the potential for greater selectivity towards sequestration of Li-ions at longer cycle times, which is again consistent with the ordering of solid-state diffusion coefficients of the three ions in ζ-V₂O₅. DFT (density functional theory) simulations have shown that barriers to Li-ion diffusion are 0.13-0.14 in ζ-V₂O₅ depending on the Li-ion stoichiometry; activation energies for Na-ion diffusion are substantially higher at 0.47-0.95 eV.

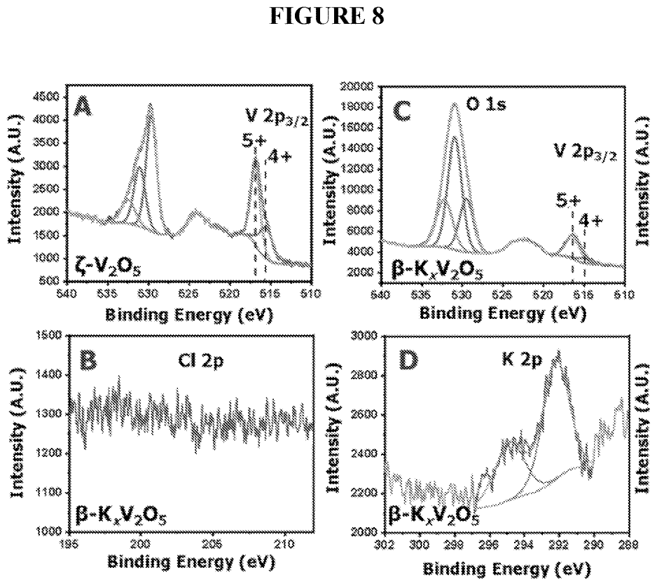

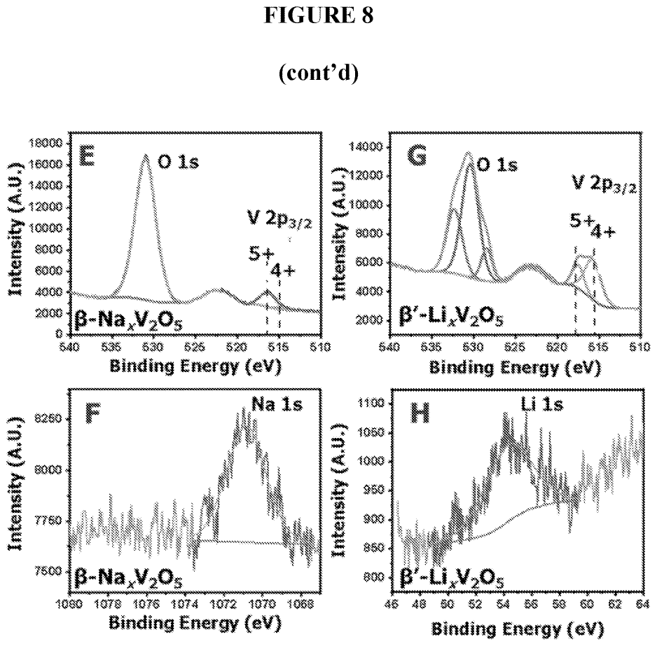

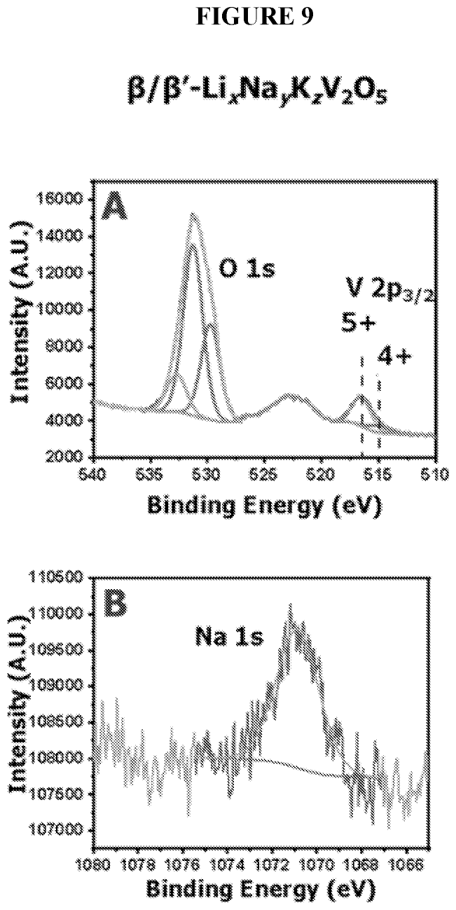

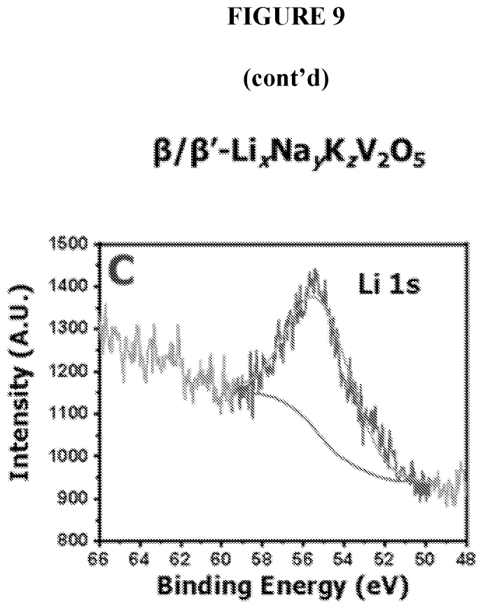

X-ray photoelectron spectroscopy (XPS) data was acquired for recovered electrodes after ion sequestration cycles and washing with deionized water to remove adsorbed ions (FIG. 8 and FIG. 9). Li is, Na is, and K 2p peaks are observed at 56, 1070, and 292 eV, respectively, corroborating the presence of the intercalated ions. The as-prepared ζ-V₂O₅ positive electrode material showed vanadium and oxygen manifolds centered at binding energies of 517 and 530 eV, respectively. Upon lithiation, a low-energy shoulder increases for the V 2p_{3/2} peaks corresponding to vanadium reduction (FIG. 8, FIG. 9). The observed reduction of V to its tetravalent form indicates intercalation of ions to form β-MₓV₂O₅, which evidences redox intercalation of ions within the 1D tunnels of ζ-V₂O₅. A low-energy shoulder to the V 2p_{3/2} peak is likewise observed in the β-KₓV₂O₅ material with a lesser degree of reduction for β-NaᵣV₂O₅.

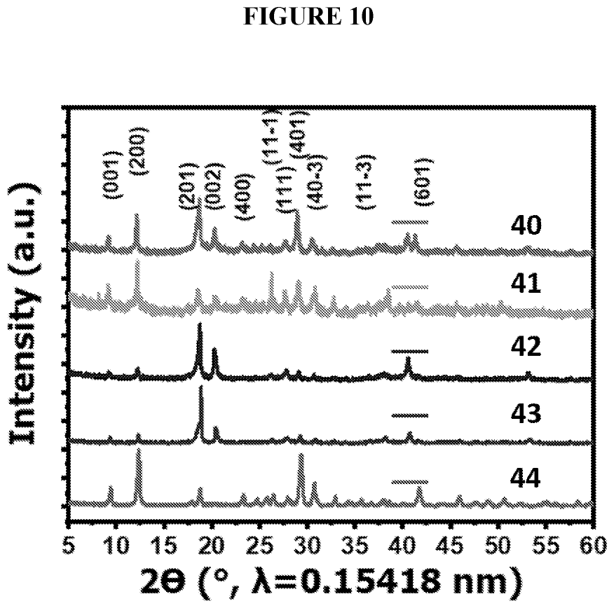

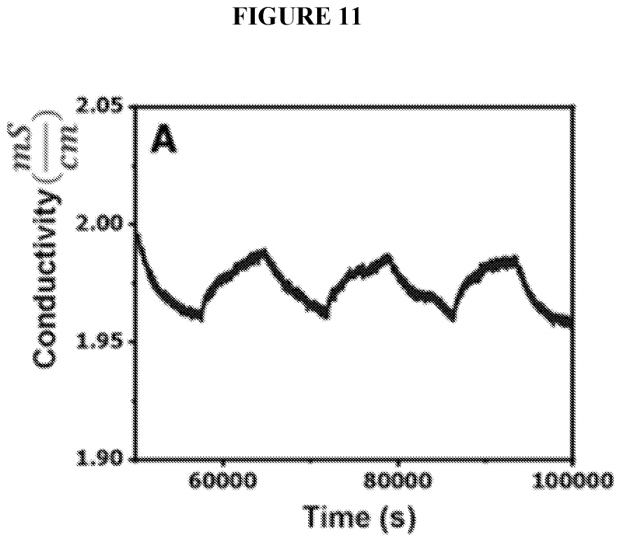

XPS is exceedingly surface sensitive and thus to obtain definitive evidence for ion intercalation (and not just surface adsorption), we have performed powder XRD measurements on recovered ζ-V₂O₅ electrodes after ion sequestration cycles. FIG. 10 contrasts powder XRD patterns acquired for samples after HCDI removal of Li-, Na-, and K-ions with the XRD pattern of as-prepared ζ-V₂O₅. Electrochemical cycling of a HDCI cell took place with electrodes cycled with 15 mM solutions of KCl (1003), NaCl (1002), and LiCl (1001) and a solution of 5 mM LiCl, 5 mM NaCl, and 5 mM LiCl in deionized water (1000). The labels to each XRD pattern in FIG. 10 denote stoichiometries measured by ICP-MS.

Pawley refinements were performed to the powder XRD data; the refined lattice parameters are listed in Table 2. The recovered samples are still crystallized in the monoclinic structure with a C2/m space group. However, substantial volume expansion of 1.9%, 1.2%, and 0.4% is observed upon K⁺, Li⁺, and Na⁺ insertion, respectively (Table 2). The observed changes in lattice parameters and expansion of the unit cell are consistent with the intercalation stoichiometries derived from ICP-MS noted in Table 2. Similar lattice expansion has been observed for non-aqueous intercalation in ζ-V₂O₅ single crystals, corroborating the occupancy of interstitial sites within the tunnel and the operation of Faradaic reactions at the charged interfaces of the HCDI cell.

Notably, below a threshold stoichiometry of x˜0.33 in LiₓV₂O₅, inserted Li-ions initially occupy 5-coordinated β-sites (FIG. 2D-F) within the V₂O₅ tunnels, which engenders only modest distortion of the lattice; however, as the Li occupancy increases, cation reordering is observed, accompanied by tunnel expansion, and the Li-ions are arrayed along more closely spaced 4-coordinated β′ sites (FIG. 2D-F). This allows for a Li-ion stoichiometry of up to x˜0.67. However, Na- and K-ions cannot be accommodated within β′ sites and are accommodated up to maximum stoichiometries of ˜0.33 per formula unit, being confined to the β-sites shown in FIG. 2D-F.

Table 1 shows ICP-MS results and unit cell parameters derived from a Pawley refinement for positive electrode materials that have been cycled with 15 mM LiCl, 15 mM NaCl, 15 mM KCl, and a mixed salt solution containing 5 mM LiCl, 5 mM NaCl, and 5 mM KCl:

TABLE 2

| | | | | | Unit Cell | % |
|---|---|---|---|---|---|---|
| ICP-MS | a | b | C | β | Volume | Expansion |
| ζ-V₂O₅ | 15.31 | 3.6 | 10.07 | 109.8 | 522.6 | 0.0 |
| β′-Li_{0.66}V₂O₅ | 15.19 | 3.63 | 10.07 | 108 | 528.9 | 1.2 |
| β-Na_{0.18}V₂O₅ | 15.19 | 3.63 | 10.04 | 108.3 | 524.9 | 0.4 |
| β-K_{0.07}V₂O₅ | 15.25 | 3.63 | 10.09 | 107.8 | 532.4 | 1.9 |
| β-Li_{0.33}Na_{0.1}K_{0.05}V₂O₅ | 15.23 | 3.63 | 10.06 | 108.15 | 529.2 | 1.3 |

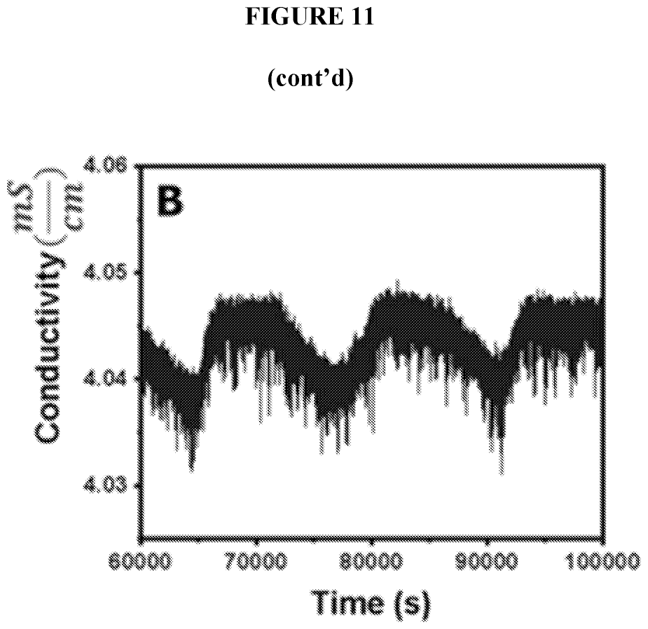

Competitive sequestration from a mixed salt stream can be measured. FIG. 11A shows the electrochemical performance of HCDI cells with ζ-V₂O₅ positive electrodes in the removal of cations from a mixed aqueous solution of LiCl, NaCl, and KCl at different half cycle times at a flow rate of 20 mL/min and an applied potential of 1.2 V. ICP-MS results in Table 2 illustrate a strong preference for Li-ion insertion after 2 hours. Li-ions are 33% of the cations in solution but represent 68% of the intercalated ions (Table 2), thus illustrating a means of selective sequestration. This was further corroborated by the XPS results in FIG. 8 and FIG. 9. The high-resolution V 2p XPS spectra in FIG. 8 and FIGS. 9 and 6 show a clear shoulder between 515-516 eV indicating the presence of tetravalent vanadium, which is suggestive of significant ion intercalation.

Powder XRD results in FIG. 9 further demonstrated a 1.3% lattice expansion of ζ-V₂O₅ upon insertion of ions from the mixed salt flowstream. This indicates that the kinetics of HCDI using ζ-V₂O₅ electrodes are dependent to a large extent on the hydrated ion size and hydration energy, a lower hydration energy is conducive to higher ionic conductivity and easier desolvation at interfaces of insertion electrodes. However, the IRC at extended times, when desolvation is no longer the limiting process, is proportional to the availability of interstitial sites and the site-to-site migration barriers of bare ions. The results provide unequivocal evidence for intercalative cation sequestration and suggest a means of engendering ion selectivity.

In an attempt to evidence the real-world potential of a ζ-V₂O₅ positive electrode material for desalination and selective ion sequestration in a HCDI configuration, FPW samples from a hydraulic fracturing operation in West Texas were flowed through the flow cell configuration depicted in FIG. 1 after being filtered for residual oil and dissolved solids. The resulting aqueous solution had an extremely high salt content, which necessitated dilution of the sample to 10% of its initial concentration prior to desalination. The salt content of the FPW was measured by ICP-MS (Table 3). A diluted sample cycled through the HCDI cell shows effective removal of ionic impurities (FIG. 10B). While evidence of sequestration in the porous ζ-V₂O₅ electrode is observed for each of the ions identified in the initial solution, the ICP-MS results in Table 3 provide clear evidence for selective sequestration of Li-ions. The results demonstrate clear evidence of the viability of ζ-V₂O₅ as a positive electrode material for effective desalination and Li-ion extraction from FPW.

Table 1 shows ICP-MS results of the ionic composition of residual salt upon evaporation of FPW. The water was first filtered to remove residual oil and dissolved solids using a cement-based membrane and then salt was recovered through evaporation of the aqueous phase. These results were contrasted with ICP-MS results of the intercalated ion content of a ζ-V₂O₅ positive electrode after flowing a FPW stream as shown in FIG. 5.

TABLE 3

| | Li | Na | K | Mg | Ca | Sr |
|---|---|---|---|---|---|---|
| Salt | 0.35% | 94.03% | 0.95% | 1.02% | 3.25% | 0.40% |
| composition | | | | | | |
| (at. %) | | | | | | |
| Sequestered | 7.29% | 24.27% | 20.38% | 13.66% | 33.38% | 1.01% |
| ions | | | | | | |
| (at. %) | | | | | | |

As demonstrated, a tunnel-structured ζ-V₂O₅ insertion host serves as an effective positive electrode material for desalination of aqueous salt solutions in a HCDI configuration. Ion removal experiments were performed at varying half-cycle times with aqueous solutions containing Li⁺, Na⁺, K⁺, a mixed salt solution containing all three ions, and a filtered FPW stream from the Permian Basin. The HCDI cell demonstrates about 50% superior Li⁺- and K⁺-removal from aqueous flow streams and about 16% improvement in IRC for Na⁺ as compared to CDI cells built according to the same specifications deployed within an identical cell architecture. ICP-MS and XPS data corroborate ion sequestration within the active ζ-V₂O₅ electrodes; the latter points to the reduction of vanadium, suggesting the operation of Faradaic processes. Pawley refinements to powder XRD data unambiguously establish that ion sequestration occurs through ion insertion in the interstitial sites of the 1D tunnel of ζ-V₂O₅. The kinetics of ion removal show considerable dependence on the free energy of hydration, which governs the ease of desolvation at the electrode/electrolyte interface. At longer time periods, the IRC is a function primarily of the ionic radius of the bare ion and its solid-state diffusion coefficient. ζ-V₂O₅ positive electrodes show substantial selectivity for Li⁺ removal from mixed flowstreams and enrichment of Li-ion concentration from FPW. HCDI with ζ-V₂O₅ positive electrodes thus shows promise not only to clean FPW but also to selectively extract valuable minerals needed for the energy transition.

The HDCI cell using ζ-V₂O₅ electrodes and systems including the HDCI cell disclosed herein may also be used in remote operations by mounting such a system on a mobile vehicle, such as a truck, or on a trailer that could be moved by a vehicle. An exemplary remote mounted HDCI system could include: (i) connectors and/or tubing to connect the system to one or more produced water or other aqueous solution storage tanks; (ii) one or more membranes/filters for deoiling and desilting; (iii) a nanofiltration unit; (iv) an HDCI cell with ζ-V₂O₅ as the positive electrode; (v) a water softening unit; (vi) a system for atmospheric plasma treatment; and (vii) one or more absorption columns. Preferably the components of such an HDCI system would be secured to the vehicle or trailer in order to prevent damage during transit. Such an HDCI system could also include a control system, power source (such as a generator, battery, or solar panels), pumps, and/or other equipment necessary to cause an aqueous solution to flow through the system, including in the manner described below.

In an exemplary method using such an HDCI system to desalinate produced water and recover lithium at remote sites, the produced water would enter the system through a conduit and flow through deoiling and desilting membranes to remove residual oils and dissolved solids. The resulting aqueous solution would flow through a nanofiltration unit into the HDCI cell that uses ζ-V₂O₅ positive electrodes to separate a lithium-enriched brine from devalorized water. The lithium-enriched brine flows into the atmospheric plasma treatment system that uses a liquid effluent for plasma treatment of the brine to enable recovery of battery grade Li₂CO₃. After treatment through the nanofiltration unit, some part of the remaining aqueous solution could be diverted to a water softener and flowed through absorption columns in order to recover both devalorized water and a brine enriched for copper and colbalt.

### EXAMPLES

### Example 1. Synthesis of ζ-V₂O₅

ζ-V₂O₅ was synthesized using a previously reported method (see Marley, P. M.; Abtew, T. A.; Farley, K. E.; Horrocks, G. A.; Dennis, R. V.; Zhang, P.; Banerjee, S., Emptying and filling a tunnel bronze. Chemical Science 2015, 6 (3), 1712-1718). In brief, silver acetate (0.2811 g)(Alfa Aesar) and α-V₂O₅ (0.9189 g)(EMD Millipore) were ball milled for 30 min in a SPEX SamplePrep 5100 Mixer Mill using methacrylate grinding beads. Next, 0.33 g of the resulting mixture was added to 16 mL of deionized water (Bamstead International NANOpure Diamond system ρ=18.2 MO-cm) and placed inside a polytetrafluoroethylene vessel, which was inserted into a Parr Instrument Company steel acid digestion vessel. The sealed hydrothermal vessel was heated at 210° C. for 72 h. Upon cooling the vessels to room temperature, the resulting green precipitate (β-Ag_{0.33}V₂O₅) was filtered and subsequently washed with copious amount of water and 2-propanol. The resulting β-Ag_{0.33}V₂O₅ (0.33 g) was added to a polytetrafluoroethylene cup with 15 mL of deionized water (ρ=18.2 MΩ·cm) and 0.8 mL of HCl (12 M) (Avantor) and again placed in a Parr Instrument Company steel acid digestion vessel. The hydrothermal vessel was heated at 210° C. for 24 h. Upon cooling the vessels to room temperature, the resulting brown precipitate ζ-V₂O₅, AgCl) was filtered and subsequently washed with copious amount of deionized water (ρ=18.2 MΩ·cm) and 2-propanol. AgCl was then removed by treating the precipitate with 0.5 M Na₂S₂O₃ followed by washing with copious amounts of deionized water (ρ=18.2 MO-cm).

### Example 2. Building and Testing an HDCI Cell Using ζ-V₂O₅ as the Positive Electrode

The positive electrode material for HCDI cells were prepared by mixing 160 mg of the active material (ζ-V₂O₅), 30 mg of Super-C45 conductive carbon black, and 1 mL of 10 wt. % PVDF in N-methyl-2-pyrrolidone (NMP). The resulting slurry was stirred by hand for 30 min until an even viscous slurry was formed. The slurry was then cast onto battery grade aluminum foil with a thickness of 15 μm using a BYK casting knife at a thickness of 0.25 mm. The cast electrodes were dried in a muffle furnace at 70° C. for 24 h.

The negative electrode material for HCDI and both the negative and positive electrode material for CDI cells were prepared by mixing 160 mg of the active material (Strem Chemicals activated carbon with a surface area of 1300-1400 m²/g), 30 mg of Super-C45 conductive carbon black, and 1 mL of 10 wt. % PVDF in N-methyl-2-pyrrolidone (NMP). The resulting slurry was stirred by hand for 30 min until an even viscous slurry was formed. The slurry was then cast onto battery grade aluminum foil with a thickness of 15 μm using a BYK casting knife at a thickness of 0.25 mm. The cast electrodes were dried in a muffle furnace at 70° C. for 24 h.

A custom HCDI cell was constructed using a Delrin exterior as depicted in FIG. 1. The interior of the HCDI cell comprises a current collector (15.24 cm×5.08 cm conductive copper tape), the positive electrode material (1 cm×4 cm) (preferably. ζ-V₂O₅), a cation-exchange membrane (1.5 cm×4.5 cm Nafion 115), 2 layers of a Nylon separator material (78 μm×100 μm pore size VWR), a custom Viton gasket ( 1/32 in McMaster Carr), 2 layers of separator (78 μm×100 μm pore size VWR), an anion-exchange membrane (Fumasep FAA-3-PK-130), the negative electrode material, and a current collector (15.24 cm×5.08 cm conductive copper tape). These components were then sandwiched between the Delrin exterior and connected to a peristaltic pump (Omega FPU 421). Various aqueous salt solutions containing 15 mM of NaCl, LiCl, or KCl in deionized water or a combination of all three salts were then flowed through the cell at a rate of 20 ml/min.

An FPW sample acquired from West Texas was also tested. The sample was recovered from a well from Southern Midland in the Permian Basin of West Texas. The sample was filtered using a cement-based membrane by Rivera-Gonzalez et al. and then diluted to 10% of its initial concentration using deionized water (Barnstead International NANOpure Diamond system ρ=18.2 MΩ·cm). The HCDI cell was connected to a Gamry Interface 1010E potentiostat in repeating chronoamperometry mode. A voltage of 1.2 V was applied to the cell for time periods of 15 min. 30 min, 1 h, and 2 h at which point the potential was reversed to −1.2 V for a total of 40 cycles. The change in conductivity was measured using a combination ET915 Conductivity Electrode and EPU357 Conductivity iosPod, and was plotted as a function of time.

A CDI cell was constructed and used for control testing using a Delrin exterior as depicted in FIG. 1. The interior of the CDI cell comprises a current collector (15.24 cm×5.08 cm conductive copper tape), the positive electrode material (1 cm×4 cm), a cation-exchange membrane (1.5 cm×4.5 cm Nafion 115), 2 layers of a Nylon separator material (78 μm×100 μm pore size VWR), a custom Viton gasket ( 1/32 in McMaster Carr), 2 layers of separator (78 μm×100 μm pore size VWR), an anion-exchange membrane (Fumasep FAA-3-PK-130), the negative electrode material, and a current collector (15.24 cm×5.08 cm conductive copper tape). These components were then sandwiched between the Delrin exterior and connected to a peristaltic pump (Omega FPU 421). Various aqueous salt solutions containing 15 mM of NaCl, LiCl, or KCl in deionized water or a combination of all three salts were then flowed through the cell at a rate of 20 mL/min. The CDT cell was connected to a Gamry Interface 1010E potentiostat in repeating chronoamperometry mode. A voltage of 1.2 V was applied to the cell for time periods of 15 min, 30 min, 1 h, and 2 h at which point the potential was reversed to −1.2 V for a total of 40 cycles. The change in conductivity was measured using a combination ET915 Conductivity Electrode and EPU357 Conductivity iosPod, and was plotted as a function of time.

Ion removal capacity was calculated by first plotting a calibration curve for each aqueous salt solution by recording the change in ionic conductivity as a function of salt concentration. The change in conductivity after an ion removal step was converted to concentration using the calibration curve and averaged across each measurement. The first few cycles correspond to conditioning steps. The ion removal capacity was then calculated using Equation 1 where C₀ and Cᵢ are the salt concentration before and after cycling, respectively; V is the solution volume; and Mₜₒₜ is the mass of both electrodes including the active material as well as the carbon black and binder material:

$$Ion Removal Capacity ( IRC ) ( \frac{mg}{g} ) = \frac{( {C}_{0} - {C}_{i} ) * V}{{M}_{tot}} \qquad ( 1 )$$

### Example 3. Characterization

Powder X-ray diffraction (XRD) was performed on cycled positive electrode samples using a Bruker-AXS D8 Endeavor powder X-ray Diffractometer equipped with a Lynxeye PSD XTE detector and a copper Kα source (λ=1.5418 Å). A Pawley refinement was performed on the collected diffraction patterns.

XPS experiments were conducted using Mg Kα X-rays (source energy of 1253.6 eV) in an Omicron DAR 400 XPS/UPS system equipped with a 128-channel micro-channel plate Argus detector, and a CN10 electron flood source to neutralize sample charge. The instrumental energy resolution was approximately 0.8 eV. High-resolution fine spectra composited from triplicate acquisitions were collected at a pass energy of 100 eV (in constant analyzer energy mode), with an energy step size of 0.05 eV, and with a dwell time of 200 ms. All high-resolution spectra were calibrated using the C 1s line of adventitious carbon at 284.5 eV. Spectral line-shape fitting was performed with the CasaXPS 2.3.16 software applying the Marquardt-Levenberg optimization algorithm.

Inductively coupled plasma mass spectrometry (ICP-MS) was performed on cycled positive electrode samples and used to determine the raw analyte concentration of V⁵¹, Li⁷, Na²³, and K³⁹ using a PerkinElmer NExION300D instrument benchmarked to a Sc⁴⁵ internal standard. Samples were prepared for ICP-MS analyses by removing the electrode material after an ion uptake cycle and washing 3× with 50 mL deionized water (Barnstead International NANOpure Diamond system ρ=18.2 MΩ·cm) in order to remove surface-adhered ions. The washed electrodes were then dried under nitrogen on a Schlenk line and digested in concentrated nitric acid at 100° C. in a water bath in a sealed centrifuge tube. The solution was then diluted with Milli-Q-purified H₂O until the estimated concentration of ions was in the 1-100 ppb range. The measured concentration of metal ions has a relative uncertainty of 5%.

### REFERENCES

Mekonnen, M. M.; Hoekstra, A. Y., Four billion people facing severe water scarcity. Science advances 2016, 2 (2), e1500323.
Chang, H.; Li, T.; Liu, B.; Vidic, R. D.; Elimelech, M.; Crittenden, J. C., Potential and implemented membrane-based technologies for the treatment and reuse of flowback and produced water from shale gas and oil plays; A review. Desalination 2019, 455, 34-57.
Zhang, Y.; Mao, J.; Mao. J.; Chen, A.; Yang, X.; Lin, C.; Wei, Z.; Huang, X.; Song, L.; Tang, F., Jiang, Q.; Ni, Y., Towards sustainable oil/gas fracking by reusing its process water: A review on fundamentals, challenges, and opportunities. Journal of Petroleum Science and Engineering 2022, 213, 110422.
Alabi, A.; AlHajaj, A.; Cseri, L.; Szekely, G.; Budd, P.; Zou, L., Review of nanomaterials-assisted ion exchange membranes for electromembrane desalination. npj Clean Water 2018, 1 (1), 10.
Abraham, J.; Vasu, K. S.; Williams, C. D.; Gopinadhan, K.; Su, Y.; Cherian, C. T.; Dix, J.; Prestat, E.; Haigh, S. J.; Grigorieva, I. V.; Carbone, P.; Geim, A. K.; Nair, R. R., Tunable sieving of ions using graphene oxide membranes. Nature Nanotechnology 2017, 12 (6), 546-550.
Gamaethiraalage, J. G.; Singh, K.; Sahin, S.; Yoon, J.; Elimelech, M.; Suss, M. E.; Liang, P.; Biesheuvel, P. M.; Zomitta, R. L.; de Smet, L. C. P. M., Recent advances in ion selectivity with capacitive deionization. Energy Environ. Sci. 2021, 14 (3), 1095-1120.
Manchanda, H.; Kumar, M., Study of water desalination techniques and a review on active solar distillation methods. Environ. Prog. Sustain. Energy 2018, 37 (1), 444-464.
Di Vincenzo, M.; Tiraferri, A.; Musteata, V.-E.; Chisca, S.; Sougrat, R.; Huang, L.-B.; Nunes, S. P.; Barboiu, M., Biomimetic artificial water channel membranes for enhanced desalination. Nature Nanotechnology 2021, 16 (2), 190-196.
Guo, J.; Tucker, Z. D.; Wang, Y.; Ashfeld, B. L.; Luo, T., Ionic liquid enables highly efficient low temperature desalination by directional solvent extraction. Nature Communications 2021, 12 (1), 437.
Tian, L.; Chang, H.; Tang, P.; Li, T.; Zhang, X.; Liu, S., He, Q.; Wang, T.; Yang, J.; Bai, Y.; Vidic, R. D.; Crittenden, J. C.; Liu, B., Rare Earth Elements Occurrence and Economical Recovery Strategy from Shale Gas Wastewater in the Sichuan Basin, China. ACS Sustainable Chemistry & Engineering 2020, 8 (32), 11914-11920.
Liu, C.; Hsu, P.-C.; Xie, J.; Zhao, J.; Wu, T.; Wang, H.; Liu, W.; Zhang, J.; Chu, S.; Cui, Y., A half-wave rectified alternating current electrochemical method for uranium extraction from seawater. Nature Energy 2017, 2 (4), 17007.
Wang, Z.; Meng, Q.; Ma, R.; Wang, Z.; Yang, Y.; Sha, H.; Ma, X.; Ruan, X.; Zou, X.; Yuan, Y.; Zhu, G., Constructing an Ion Pathway for Uranium Extraction from Seawater. Chem 2020, 6 (7), 1683-1691.
Scanlon. B. R.; Ikonnikova. S.; Yang, Q.; Reedy, R. C., Will Water Issues Constrain Oil and Gas Production in the United States? Environ. Sci. Technol. 2020, 54 (6), 3510-3519.
Rivera-Gonzalez, N.; Bajpayee, A.; Nielsen. J.; Zakira, U.; Zaheer, W.; Handy, J.; Sill, T.; Birgisson, B.; Bhatia, M., Banerjee, S., Textured ceramic membranes for desilting and deoiling of produced water in the Permian Basin. iScience 2022, 25 (10), 105063.
Lee, J.; Kim, S.; Kim, C.; Yoon, J., Hybrid capacitive deionization to enhance the desalination performance of capacitive techniques. Energy Environ. Sci. 2014, 7 (11), 3683-3689.
Wu. T.; Wang, G.; Wang, S.; Zhan, F.; Fu, Y.; Qiao, H.; Qiu, J., Highly Stable Hybrid Capacitive Deionization with a MnO₂ Anode and a Positively Charged Cathode. Environmental Science & Technology Letters 2018, 5 (2), 98-102.
Siekierka, A.; Tomaszewska, B.; Bryjak, M., Lithium capturing from geothermal water by hybrid capacitive deionization. Desalination 2018, 436, 8-14.
Bardi, U., Extracting minerals from seawater: an energy analysis. Sustainability 2010, 2(4), 980-992.
Marley, P. M.; Abtew, T. A.; Farley, K. E.; Horrocks, G. A.; Dennis, R. V.; Zhang, P.; Banerjee, S., Emptying and filling a tunnel bronze. Chemical Science 2015, 6 (3), 1712-1718.
Luo, Y.; Rezaei, S.; Santos, D. A., Zhang, Y.; Handy, J. V.; Carrillo, L.; Schultz, B. J.; Gobbato, L.; Pupucevski, M.; Wiaderek, K.; Charalambous, H.; Yakovenko, A.; Pharr, M.; Xu, B.-X.; Banerjee, S., Cation reordering instead of phase transitions: Origins and implications of contrasting lithiation mechanisms in 1D ζ- and 2D α-V₂O₅. Proc. Natl. Acad. Sci. U.S.A. 2022, 119 (4), e2115072119.
Anderson, M. A.; Cudero, A. L.; Palma, J., Capacitive deionization as an electrochemical means of saving energy and delivering clean water. Comparison to present desalination practices: Will it compete? Electrochim. Acta 2010, 55 (12), 3845-3856.
Porada, S., Zhao, R.; van der Wal, A.; Presser, V.; Biesheuvel, P. M., Review on the science and technology of water desalination by capacitive deionization. Prog. Mater Sci. 2013, 58 (8), 1388-1442.
Folaranmi, G.; Bechelany, M.; Sistat, P.; Cretin, M.; Zaviska, F., Towards electrochemical water desalination techniques: a review on capacitive deionization, membrane capacitive deionization and flow capacitive deionization. Membranes 2020, 10 (5), 96.
Byles, B. W.; Hayes-Oberst, B., Pomerantseva, E., Ion Removal Performance, Structural/Compositional Dynamics, and Electrochemical Stability of Layered Manganese Oxide Electrodes in Hybrid Capacitive Deionization. ACS Applied Materials & Interfaces 2018, 10 (38), 32313-32322.
Kim, S.; Lee, J.; Kim, C.; Yoon, J., Na₂FeP₂O₇ as a Novel Material for Hybrid Capacitive Deionization. Electrochim. Acta 2016, 203, 265-271.
Byles, B. W.; Cullen, D. A.; More. K. L.; Pomerantseva, E., Tunnel structured manganese oxide nanowires as redox active electrodes for hybrid capacitive deionization. Nano Energy 2018, 44, 476-488.
Porada, S.; Borchardt, L.; Oschatz, M.; Bryjak, M.; Atchison, J.; Keesman, K.; Kaskel, S.; Biesheuvel, P.; Presser, V., Direct prediction of the desalination performance of porous carbon electrodes for capacitive deionization. Energy Environ. Sci. 2013, 6 (12), 3700-3712.
Kumar, A.; Fukuda, H.; Hatton, T. A.; Lienhard, J. H., Lithium recovery from oil and gas produced water: A need for a growing energy industry. ACS Energy Letters 2019. 4 (6), 1471-1474.
Whittingham, M. S., Lithium Batteries: 50 Years of Advances to Address the Next 20 Years of Climate Issues. Nano Lett. 2020, 20 (12), 8435-8437.
Handy, J. V.; Luo. Y.; Andrews, J. L.; Bhuvanesh, N.; Banerjee, S., An Atomic View of Cation Diffusion Pathways from Single-Crystal Topochemical Transformations. Angew. Chem. Int. Ed 2020, 59 (38), 16385-16392.
De Jesus, L. R.; Andrews, J. L.; Parija, A.; Banerjee, S., Defining Diffusion Pathways in Intercalation Cathode Materials: Some Lessons from V₂O₅ on Directing Cation Traffic. ACS Energy Letters 2018, 3 (4), 915-931.
Parija, A.; Liang, Y.; Andrews, J. L.; De Jesus, L. R.; Prendergast, D., Banerjee, S., Topochemically De-Intercalated Phases of V₂O₅ as Cathode Materials for Multivalent Intercalation Batteries: A First-Principles Evaluation. Chem. Mater. 2016, 28 (16), 5611-5620.
Luo, Y.; Bai, Y.; Mistry, A.; Zhang, Y.; Zhao, D.; Sarkar, S.; Handy, J. V.; Rezaei, S.; Chuang, A. C.; Carrillo, L.; Wiaderek, K.; Pharr, M.; Xie, K.; Mukherjee, P. P.; Xu, B.-X.; Banerjee, S., Effect of crystallite geometries on electrochemical performance of porous intercalation electrodes by multiscale operando investigation. Nature Materials 2022, 21 (2), 217-227.
Fraggedakis, D.; Nadkarni, N.; Gao, T.; Zhou. T.; Zhang, Y.; Han, Y.; Stephens, R. M.; Shao-Hom, Y.; Bazant, M. Z., A scaling law to determine phase morphologies during ion intercalation. Energy Environ. Sci. 2020, 13 (7), 2142-2152.
Zhong, C.; Deng, Y.; Hu, W.; Qiao, J.; Zhang, L.; Zhang, J., A review of electrolyte materials and compositions for electrochemical supercapacitors. Chem. Soc. Rev. 2015, 44 (21), 7484-7539.
Tansel, B., Significance of thermodynamic and physical characteristics on permeation of ions during membrane separation: Hydrated radius, hydration free energy and viscous effects. Sep. Purif. Technol. 2012, 86, 119-126.
Horrocks, G. A.; Parija. A.; De Jesus, L. R.; Wangoh, L.; Sallis, S.; Luo, Y.; Andrews, J. L.; Jude, J.; Jaye, C.; Fischer, D. A.; Prendergast, D.; Piper, L. F. J.; Banerjee, S., Mitigating Cation Diffusion Limitations and Intercalation-Induced Framework Transitions in a 1D Tunnel-Structured Polymorph of V₂O₅. Chem. Mater. 2017, 29 (24), 10386-10397.
Shepard, R.; Smeu, M., Ab initio investigation of α- and ζ-V₂O₅ for beyond lithium ion battery cathodes. J Power Sources 2020, 472, 228096.
Akashi, N.; Kuroda, S-i., Protein immobilization onto poly (vinylidene fluoride) microporous membranes activated by the atmospheric pressure low temperature plasma. Polymer 2014, 5S (12), 2780-2791.
Chen, X.; Wang, X.; Fang, D., A review on C1s XPS-spectra for some kinds of carbon materials. Fullerenes, Nanotubes and Carbon Nanostructures 2020, 28 (12), 1048-1058.

1. An HDCI cell for desalination comprising:
a. a positive electrode material comprised of ζ-V₂O₅;
b. a current collector;
c. a cation exchange membrane;
d. a separator layer;
e. an anion exchange membrane; and
f. a negative electrode material.

2. The HDCI cell of claim 1, wherein the positive electrode material comprised of ζ-V₂O₅ is further modified such that one or more of the vanadium sites is substituted with molybdenum, tungsten, or niobium.

3. The HDCI cell of claim 1, further comprising a Delrin exterior.

4. A method comprising:
a. electrochemically cycling an HCDI cell comprising a ζ-V₂O₅ positive electrode with an aqueous solution having a salinity above 1000 ppm; and
b. removing at least one of lithium, potassium, or sodium ions from the aqueous solution.

5. The method of claim 4, wherein the positive electrode material comprised of ζ-V₂O₅ is further modified such that one or more of the vanadium sites is substituted with molybdenum, tungsten, niobium.

6. The method of claim 4, wherein lithium ions are removed from the aqueous solution, wherein the selectivity of lithium ion removal is in a range from 10 to 10⁶ higher than for other ions.

7. The method of claim 6, further comprising: after electrochemically cycling the HCDI cell for selective removal of lithium ions, electrochemically cycling the HCDI cell for selective removal of one or more other ions and removing those other ions.

8. The method of claim 4, wherein each electrochemical cycle lasts for a duration of between 10 seconds and ninety minutes.

9. The method of claim 4, wherein the thickness of the ζ-V₂O₅ positive electrode is between 2 nm to 1000 μm.

10. The method of claim 4, wherein the temperature at which each step occurs is between 0° C. and 95° C.

11. The method of claim 4 wherein the aqueous solution is comprised of: flowback, produced water, sea water, brackish water, geothermal brines, or synthetic brines.

12. The method of claim 11 wherein the aqueous solution is one or more of flowback or produced water and further comprising filtering the aqueous solution to remove residual oil and dissolved solids before electrochemically cycling.

13. An HDCI system for desalination at remote sites comprising:
a. a conduit that may be attached to an aqueous solution storage tank;
b. one or more additional conduits through which an aqueous solution may flow;
c. a deoiling or desilting membrane connected to at least one of the conduits;
d. a nanofiltration unit connected to at least one of the conduits and connected to an HDCI cell; and
e. a vehicle or trailer to house (a)-(e),
f. wherein the HDCI cell comprises: (i) a positive electrode material comprising ζ-V₂O₅; (ii) a current collector; (iii) a cation exchange membrane; (iv) a separator layer; (v) an anion exchange membrane; and (vi) a negative electrode material.

14. The HDCI system of claim 11, wherein the system further comprises a unit for precipitation of solid material in the form of insoluble carbonates, hydroxides, or other salts.

15. The HDCI system of claim 11, wherein the system further comprises a water softening unit.

16. The HDCI system of claim 11, wherein the system further comprises an absorption column.

17. The HDCI system of claim 11, wherein the system further comprises a control system.

18. The HDCI system of claim 11, wherein the system further comprises a pump.

19. The HDCI system of claim 11, wherein the system further comprises a storage tank.

20. The HDCI system of claim 11, wherein the system further comprises a power source, wherein the power source is a generator, a battery, or a solar panel.
